(19) United States
(12) Patent Application Publication
(10) Pub. No.: US 2020/0238673 A1
(43) Pub. Date: Jul. 30, 2020

(54) ANTIMICROBIAL SHEET AND CONSTRUCTION MATERIAL COMPRISING THE SAME

(71) Applicant: HESELET INTERNATIONAL LLC, Las Vegas, NV (US)

(72) Inventor: Moung Ki JANG, Kimpo City (KR)

(73) Assignee: HESELET INTERNATIONAL LLC, Las Vegas, NV (US)

(21) Appl. No.: 16/257,248

(22) Filed: Jan. 25, 2019

(51) Int. Cl. B32B 27/18; B32B 27/30; B32B 27/10; B32B 9/00; B32B 27/36; B32B 27/32

(52) U.S. Cl. CPC B32B 27/18; B32B 7/12; B32B 27/10; B32B 9/002; B32B 27/36; B32B 27/32; B32B 2260/026; B32B 2260/028; B32B 2260/046; B32B 2264/105; B32B 2307/7145; B32B 2471/00; B32B 2311/12; B32B 2419/04; B32B 27/304

(57) ABSTRACT

Disclosed is an antimicrobial sheet formed with a base comprising a synthetic resin, the antimicrobial sheet comprising: a fine metal particle mixed to the base; and an auxiliary additive mixed to the base and the metal particle to uniformly distribute the metal particle in the formed sheet. Thus, according to the disclosure, the metal particles having the antimicrobial function is uniformly distributed throughout the entire area as integrally coupled to the base of the construction material, is excellent in durability because the particles having the antimicrobial function are positioned close to the surface of the base as integrally coupled to the base, and removes germs being in contact with the surface.

### BACKGROUND

### Field

The disclosure relates to an antimicrobial sheet and constriction materials including the same, and more particularly to an antimicrobial sheet and construction materials including the same, in which fine metal particles are included in a plate forming sheet containing a synthetic resin so as to have an improved structure for more effectively achieving an antimicrobial function.

### Description of the Related Art

A floor, a wall, a ceiling, and the like that makes a room of a building where people spend a lot of time in their life are made of various construction materials. For example, the floor includes wood, linoleum, tiles, etc., and the wall includes wallpaper, an interior film or an interior sheet, etc.

Further, according to reports, a room, for example, a living room of a building where a family spends much time has more germs than the inside of a toilet. Usually, a rag is used for cleaning the living room. It is general that a dirty rag used in cleaning the living room is washed with soap and dried naturally. Therefore, germs on the rag do not die but survive, and the floor of the living room is particularly contaminated with many germs because the floor is cleaned with the rag full of living germs.

Besides, even in a hospital or a patient's room as kind of space in a building for curing and preventing a disease, many patients die of bacterial infection or the like at home and abroad. In a case of the United States, it is known that about two million people have suffered the bacterial infection every year, and ninety to hundred thousand people die of the bacterial infection for a year. Further, death from the bacterial infection results in annual medical costs of about 4 billion dollars. This is because transmission of viruses, germs and the like source of infection is not controlled; sterilization, disinfection and the like function is not properly carried out; and the construction material for making the room of the building does not have any special antimicrobial function. Due to global climatic warming, increasing overseas trips, increasing distribution, aging population, etc., the number of deaths such bacterial infection is expected to increase.

Accordingly, the related art has proposed a tile, wallpaper, etc. having antimicrobial components to be used in the floor and the wall for forming such a room of a building.

However, the related arts are complicated and inconvenient in terms of construction work or have a poor antimicrobial function because a paint or the like having the antimicrobial function is coated on the tile, the wallpaper, etc. and not integrated into a construction material. In addition, when the floor, the wallpaper and the like construction materials are coated with an antimicrobial film, the coating film may be removed by a scratch as used for a long time or may not work properly in particular when it is thin. Further, the component having the antimicrobial function is not uniformly applied to a coating area, and it is thus difficult to expect a uniform and good antimicrobial effect throughout.

Accordingly, there is a need of an antimicrobial sheet shaped like a thin plate, which has uniform antimicrobial effects throughout the entire area, is excellent in resistance to antimicrobial/sterilization, facilitates manufacture and maintenance, is manufactured at a relatively low cost, and is applicable to a construction material or the like.

### REFERENCE LITERATURES

Korean Patent Publication No. 1998-0025594 (published on Jul. 15, 1998)
Korean Patent Publication No. 2000-0027656 (published on May 15, 2000)

### SUMMARY

An aspect of the disclosure is to provide an antimicrobial sheet in which metal particles having an antimicrobial function is not only integrally coupled to a base of a construction material but also uniformly applied throughout an entire area.

Another aspect of the disclosure is to provide an antimicrobial sheet, which is excellent in durability and kills germs on a surface thereof because particles having an antimicrobial function is positioned close to a surface of a base as integrally coupled to the base.

Still another aspect of the disclosure is to provide an antimicrobial sheet, in which metal particles having an antimicrobial function are promoted to generate ions and active oxygen, thereby maximizing and continuously keeping antimicrobial functionality.

Yet another aspect of the disclosure is to provide an antimicrobial sheet which is simple and convenient to be used as coupled to surfaces of various construction

According to an exemplary embodiment, there is provided an antimicrobial sheet formed with a base including a synthetic resin, the antimicrobial sheet including: a fine metal particle mixed to the base; and an auxiliary additive mixed to the base and the metal particle to uniformly distribute the metal particle in the formed sheet.

Further, the metal particle may include at least one of copper (Cu), silver (Ag), and zinc (Zn).

Further, the metal particle may have a size of 20˜200 μm.

Further, the auxiliary additive may include zeolite, glycol and silica.

Further, with respect to the base, the zeolite may be 3˜25 wt %, the glycol is 0.5˜30 wt %, and the silica may be 1˜10 wt %.

Further, the metal particle of 0.3 wt %˜20 wt % may be mixed with respect to the base.

Further, with respect to the base, the metal particle may include one among copper, silver and zinc and be 0.5 wt %˜20 wt %, the zeolite may be 3 wt %˜25 wt %, the glycol may be 1 wt %˜30 wt %, and the silica may be 3 wt %˜10 wt %.

Further, with respect to the base, the metal particle may include copper and silver and be 0.5 wt %˜10 wt %, and the zeolite may be 3 wt %˜20 wt %, the glycol may be 0.5 wt %˜15 wt %, and the silica may be 1 wt %˜10 wt %.

Further, with respect to the base, the metal particle may include copper, silver and zinc and be 0.3 wt %˜15 wt %, and the zeolite may be 3 wt %˜20 wt %, the glycol may be 0.5 wt %˜20 wt %, and the silica may be 1 wt %˜10 wt %.

Further, with respect to the base, the metal particle may include copper and zinc and be 1 wt %˜10 wt %, and the zeolite may be 10 wt %˜20 wt %, the glycol may be 5 wt %˜15 wt %, and the silica may be 5 wt %˜10 wt %.

Further, with respect to the base, the metal particle may include copper and zinc and be 1 wt %˜20 wt %, and the zeolite may be 5 wt %˜20 wt %, the glycol may be 5 wt %˜15 wt %, and the silica may be 5 wt %˜10 wt %.

Further, the base may include polyvinyl chloride (PVC), polyethylene terephthalate (PET) and polypropylene (PP).

According to an exemplary embodiment, there is provided a construction material with the foregoing antimicrobial sheet, wherein the antimicrobial sheet is coupled to a surface or rear of the construction material including a floor material, wallpaper, and a decorative material.

Further, the base may include a UV coating solution, and metal particles of 0.5˜10 wt %, zeolite of 3˜10 wt %, glycol of 1˜15 wt % and silica of 1˜15 wt % are mixed with respect to the UV coating solution and applied or distributed to a surface of the construction material.

### BRIEF DESCRIPTION OF THE DRAWINGS

The above and/or the aspects will become apparent and more readily appreciated from the following description of exemplary embodiments, taken in conjunction with the accompanying drawings, in which:

FIG. 1 is a conceptual view schematically showing a manufacturing process of an antimicrobial sheet according to an embodiment of the disclosure;

FIG. 2A is a cross-sectional view of a sterilized decorative tile in which the antimicrobial sheet is coupled to polyvinyl chloride (PVC) (or polyethylene terephthalate (PET) or polypropylene (PP)) base layers and PVC (or PET or PP) printed film layers;

FIG. 2B is a cross-sectional view of a sterilized self-polishing copolymer (SPC) tile in which the antimicrobial sheet is coupled to a stone plastic layer and PVC (or PET or PP) printed film layers;

FIG. 2C is a cross-sectional view of sterilized wallpaper in which the antimicrobial sheet is coupled to a paper print layer;

FIG. 2D is a cross-sectional view of a sterilized decorative film in which the antimicrobial sheet is coupled to PVC (or PET or PP) printed film layers;

FIG. 2E is a cross-sectional view of a sterilized interior film in which the antimicrobial sheet is coupled to PVC (or PET or PP) printed film layer and an acrylic adhesive layer; and

FIG. 3 is a cross-sectional view of a construction material having an ultraviolet (UV) coating layer according to another embodiment of the disclosure.

### DETAILED DESCRIPTION OF EXEMPLARY EMBODIMENTS

In the disclosure, various changes can be made and many embodiments are possible. Thus, exemplary embodiments will be illustrated in the accompanying drawings and described in the detailed description. However, it will be appreciated that the disclosure is not limited to the exemplary embodiments, and involves all the changes, equivalents or alternatives that belong to the concept and technical scope of the disclosure.

It will be understood that, although the terms first, second, etc. may be used herein to describe various elements, these elements should not be limited by these terms. These terms are only used to distinguish one element from another.

It will be understood that when an element is referred to as being ‘connected’ or ‘coupled’ to another element, it can be directly connected or coupled to the other element intervening elements may be present. In contrast, when an element is referred to as being ‘directly connected’ or ‘directly coupled’ to another element, there are no intervening elements present.

The terminology used herein is for the purpose of describing particular embodiments only and is not intended to be limiting of the invention. As used herein, the singular forms are intended to include the plural forms as well, unless the context clearly indicates otherwise. It will be further understood that the terms ‘comprises,’ ‘includes,’ etc. when used herein, specify the presence of stated features, integers, steps, operations, elements, and/or components, but do not preclude the presence or addition of one or more other features, integers, steps, operations, elements, components, and/or groups thereof.

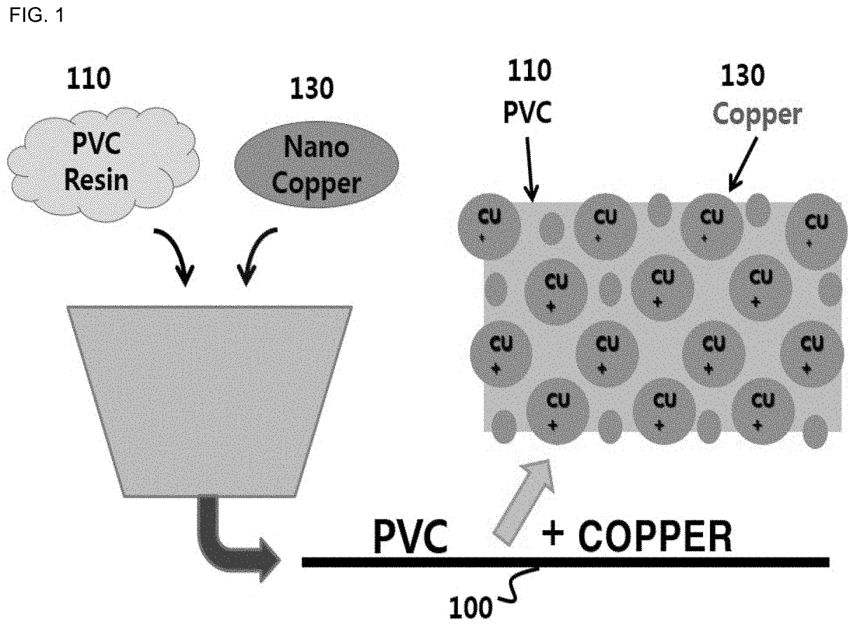

An antimicrobial sheet according to an embodiment of the disclosure will be described in detail with reference to FIGS. 1 to 3.

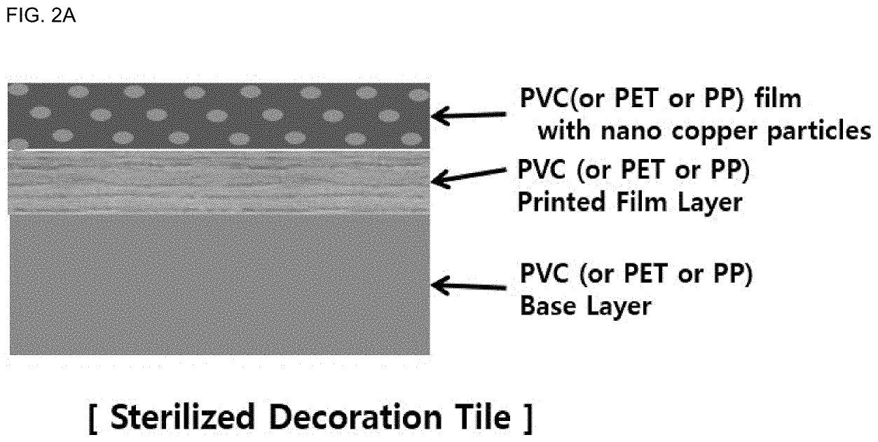

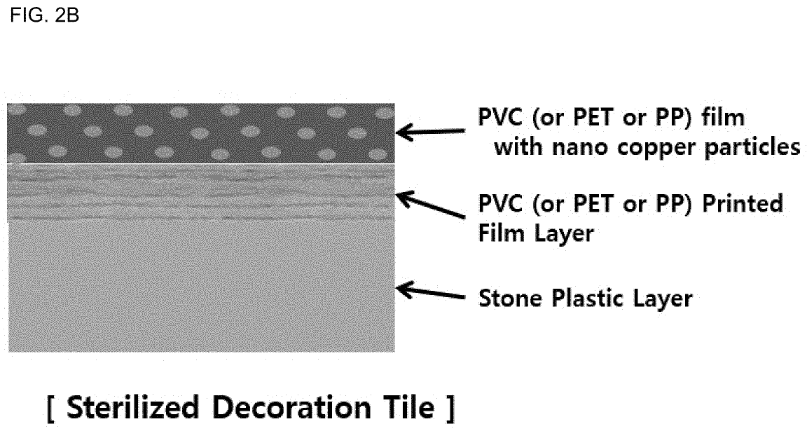

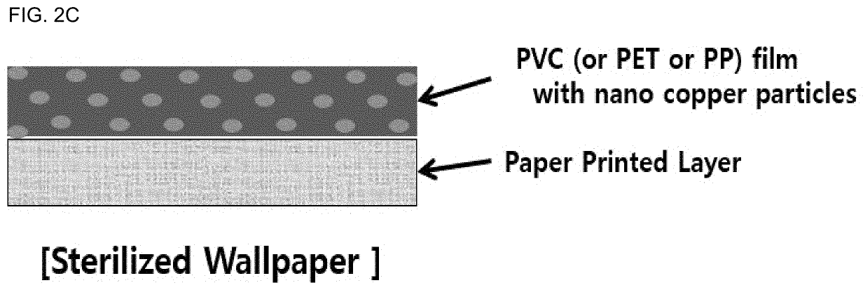

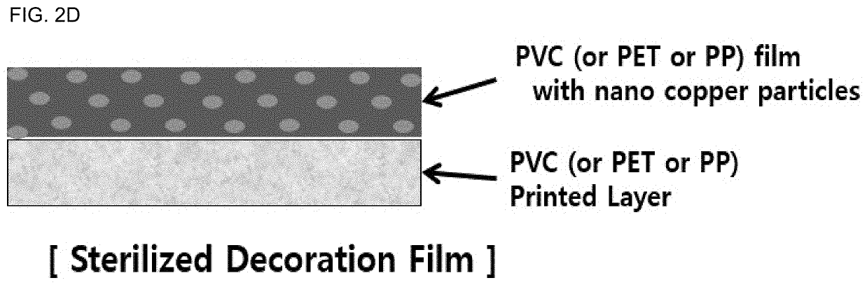

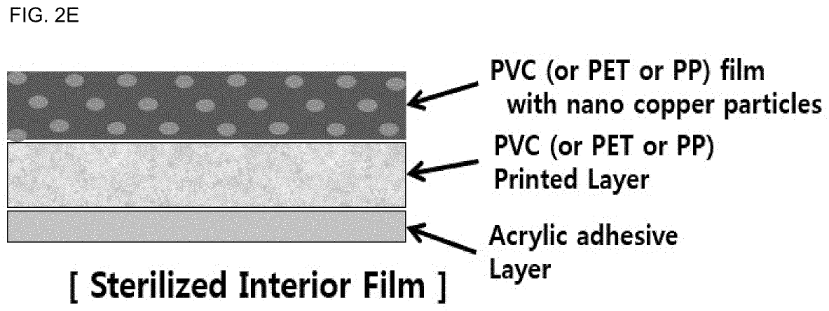

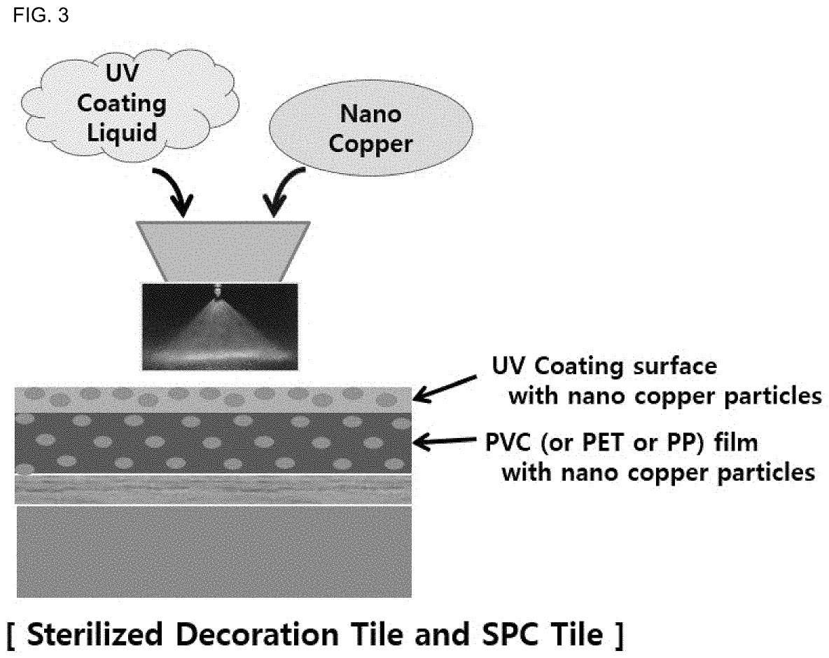

FIG. 1 is a conceptual view schematically showing a manufacturing process of an antimicrobial sheet according to an embodiment of the disclosure; FIG. 2A is a cross-sectional view of a sterilized decorative tile in which the antimicrobial sheet is coupled to polyvinyl chloride (PVC), polyethylene terephthalate (PET) or polypropylene (PP) base layers and PVC, PET or PP printed film layers; FIG. 2B is a cross-sectional view of a sterilized self-polishing copolymer (SPC) tile in which the antimicrobial sheet is coupled to a stone plastic layer and PVC, PET or PP printed film layers; FIG. 2C is a cross-sectional view of sterilized wallpaper in which the antimicrobial sheet is coupled to a paper print layer; FIG. 2D is a cross-sectional view of a sterilized decorative film in which the antimicrobial sheet is coupled to PVC, PET or PP printed film layers; FIG. 2E is a cross-sectional view of a sterilized interior film in which the antimicrobial sheet is coupled to PVC, PET or PP printed film layer and an acrylic adhesive layer; and FIG. 3 is a cross-sectional view of a construction material having a ultraviolet (UV) coating layer according to another embodiment of the disclosure.

According to an embodiment of the disclosure, an antimicrobial sheet 100 formed with a base 110 containing a synthetic resin (hereinafter, referred to as a ‘antimicrobial sheet’) includes fine metal particles 130 contained in the base 110; and auxiliary additives (not shown) contained in the base 110 and the metal particles 130 so as to be uniformly distributed in the sheet formed containing the metal particles 130. Here, the metal particles 130 may include at least one of copper (Cu), silver (Ag) and zinc (Zn), and may also include combination of these metal particles 130 to be described later. Such a metal particle 130 may have a size of 20˜200 μm. When the metal particles 130 are larger than the size of 200 μm, the metal particles 130 have a strong tendency to sink due to specific gravity while forming a thin antimicrobial sheet 100, and therefore it is difficult to uniformly distribute the metal particles 130 after a product is formed. Thus, the metal particles 130 are likely to agglomerate in an end product. Further, when the metal particle 130 is too big, the metal particles 130 may be exposed to the outside and thus make a surface not smooth. On the other hand, when the metal particle 130 is too small, there is a limit to making the metal particles 130 small and there is a concern over stability (or safety) such as danger of explosion or the like.

Here, copper has an atomic number of 29, and is useful for various purposes as many as the expressions of copper alloys. For example, there are copper alloys such as bronze, brass and white copper, which respectively consist of tin, zinc and nickel and are named according to colors. Copper has good malleability and ductility, and is soft but becomes hard with addition of other elements. Copper is importantly used for many purposes in modern times, and there are an electric cable, a pipe for a heater, a radiator for a vehicle, a material for a roof, cookware, coin, etc. as examples of a familiar copper product. Copper has an antimicrobial function, and is harmless to humans.

Silver has an atomic number of 47, and its element symbol is ‘Ag’. In the periodic table, silver is in the same group as copper (Cu), gold (Au), etc. Silver is very excellent in malleability and ductility, and is soft but a little harder than gold. Among all metals, pure silver at room temperature has the highest electric conductivity and the highest thermal conductivity, looks the whitest, has the highest reflectivity of light, and the lowest contact resistance with other metals. Silver has been conventionally used in coins (a silver coin and a silver alloy coin), medals, accessories, silverware, etc., but is currently used for various commercial purposes such as electric contact with an electronic product or conduct, an amalgam for filling a cavity of a tooth, a solder, ink, a reflection plate for a mirror or the like, a battery, etc. Silver ions and silver compounds are poisonous to some organisms such as viruses, algae, mold, etc. but harmless to humans, and therefore used in antimicrobial and antibiotic treatment.

Zinc has an atomic number of 30, and its atomic symbol is ‘Zn’. Zinc is bluish-white metal which is hard and friable with little malleability and ductility at room temperature but is so malleable at a temperature of 100˜150° C. as to be processed as a fine line or a thin plate. Zinc is a relatively good electric conductor, has relatively low melting and boiling points, and easily sublimates. The most common use of zinc is anticorrosive plating for iron. Further, zinc is used to be alloyed with different metal like brass. Zinc is a microelement essential for almost every living thing, and zinc is the second most transition metal in a human body after iron. As an element of many enzymes, Zinc affects synthesis and degradation of biomolecules such as carbohydrates, protein, nucleic acid, etc., and also affects growth, skeletogeny, reproduction and immune function. Zinc sulfide (ZnS) is used in luminous paint, deodorant, additives of an anti-dandruff shampoo, a wood preservation agent, antimicrobial agricultural chemicals, etc.

That is, the foregoing metal particles, i.e. copper, silver, and zinc are metal having the antimicrobial or sterilization function.

The auxiliary additives to be contained in the base 110 may include zeolite, glycol and silica. Here, zeolite may be 3˜25 wt %, glycol may be 0.5˜30 wt %, and silica may be 1˜10 wt %. Of course, the auxiliary additives may be mixed with the base 110 and the metal particles 130.

The base 110 may include PVC, PET, PP, and UV coating solution, and may additionally include various kinds of synthetic resin.

Here, zeolite serves as a catalyst for the metal particles and causes the metal particles to release more ions and active oxygen, thereby making the released ions and active oxygen be easily adsorbed to germs harmful to humans and enhancing antimicrobial or sterilization activity.

Further, glycol makes the fine metal particles be uniformly distributed throughout a wide area, and silica makes the fine metal particles be uniformly distributed in a relatively narrow unit area. Such glycol and silica make the metal particles having high specific gravity be uniformly distributed in the base 110, thereby functioning to uniformly distribute the metal particles 130 in the wide area and the narrow area when the antimicrobial sheet 100 is manufactured as a long and thin plate type.

Here, a procedure of manufacturing the antimicrobial sheet 100 shaped like a thin plate and a procedure of carrying out the antimicrobial activity will be described.

First, it will be assumed that copper is used as the metal particle 130 and PVC is selected as the base 110. As shown in FIG. 1, a base of a PVC resin, copper nano-powder 130, and natural ingredients of zeolite, glycol, silica, etc. are thoroughly mixed to manufacture a PVC film containing metal nanoparticles 130 of copper, i.e. the antimicrobial sheet 100. To prevent heavy copper particles of high specific gravity from sinking during such a mixing procedure, the mixture is agitated and made in the form of a compound. This compound is heated and liquefied at a high temperature and then passed through a plurality of nozzles or between rollers, thereby forming the antimicrobial sheet 100 of a typical thin sheet.

By catalysis of zeolite, copper ions (Cu²⁺) and activated oxygen are more activated and released from copper contained in the antimicrobial sheet 100 and reach germs' cell membrane, thereby destructing a structure of a cell while being adsorbed to a cell membrane or the like protein. The copper ions adsorbed to the protein such as a cell membrane, an enzyme, etc. are coupled to a cysteine group of composition amino acid, and slow down energy metabolism of a cell, and the amino acid is turned into a sulfide. Meanwhile, activated oxygen is partially turned into active oxygen (O²⁺, O²⁻, O) by catalysis of copper ions, and active oxygen carries out strong disinfection action like ozone or hydrogen peroxide.

For effective sterilization or antimicrobial action of nano copper particles, more metal ions and activated oxygen have to be released. To this end, natural zeolite having an excellent effect on the catalysis of the nano copper particles is used.

Further, copper has a specific gravity of 8˜9, which is considerably higher than other metals (e.g. iron has a specific gravity of about 7), and therefore has a disadvantage of quickly sinking down even through it has a nanosized diameter. To uniformly distribute nano copper particles to the base 110, i.e. the PVC film, glycol is used.

In such a manufactured antimicrobial sheet 100, the metal particles 130 including copper in a unit area of 10 mm*10 mm may for example be uniformly distributed within an error range of ±10%.

Embodiments based on such a manufacturing method will be described as follows.

### Embodiment 1

An antimicrobial sheet was manufactured by mixing a base with metal particles, i.e. 0.5˜20 wt % copper, 3˜25 wt % zeolite, 1˜30 wt % glycol, and 3˜10 wt % silica with respect to 100 wt % base.

### Embodiment 2

An antimicrobial sheet was manufactured by mixing a base with metal particles, i.e. 0.5˜20 wt % silver, 3˜25 wt % zeolite, 1˜30 wt % glycol, and 3˜10 wt % silica with respect to 100 wt % base.

### Embodiment 3

An antimicrobial sheet was manufactured by mixing a base with metal particles, i.e. 0.5˜20 wt % zinc, 3˜25 wt % zeolite, 1˜30 wt % glycol, and 3˜10 wt % silica with respect to 100 wt % base.

### Embodiment 4

An antimicrobial sheet was manufactured by mixing a base with metal particles, i.e. 0.3˜15 wt % copper, silver and zinc, 3˜20 wt % zeolite, 0.5˜20 wt % glycol, and 1˜10 wt % silica with respect to 100 wt % base.

### Embodiment 5

An antimicrobial sheet was manufactured by mixing a base with metal particles, i.e. 0.5˜10 wt % copper and silver, 3˜20 wt % zeolite, 0.5˜15 wt % glycol, and 1˜10 wt % silica with respect to 100 wt % base.

### Embodiment 6

An antimicrobial sheet was manufactured by mixing a base with metal particles, i.e. 1˜10 wt % copper and zinc, 10˜20 wt % zeolite, 5˜15 wt % glycol, and 5˜10 wt % silica with respect to 100 wt % base.

### Embodiment 7

An antimicrobial sheet was manufactured by mixing a base with metal particles, i.e. 1˜10 wt % silver and zinc, 5˜20 wt % zeolite, 5˜15 wt % glycol, and 5˜10 wt % silica with respect to 100 wt % base.

Results of comparison in performance between the antimicrobial sheet 100 including the metal particles 130 of copper with the PVC base 110 according to the embodiment 1 and a conventional antimicrobial film 300 formed by coating a PVC film 310 with an antimicrobial coating film 330 are tabulated in <Table 1>.

Here, CS17 is a kind of sandpaper.

The antimicrobial sheet 100 of the disclosure used in this case was manufactured according to the embodiment 1 by mixing a PVC base with 2 wt % copper, 5 wt % zeolite, 2 wt % glycol, and 3 wt % silica to have a thickness of 2 mm and have a width of 20 mm and a length of 20 mm. In the related art, a kind of antimicrobial coating film was prepared to have a thickness of 1˜2 μm, and the PVC film for the base was prepared to have a thickness of 2 mm, and have the same width and length as those of the disclosure.

The foregoing Table shows results of culturing germs after the antimicrobial sheet 100 using the PVC base according to the disclosure and the conventional PVC film coated with the antimicrobial coating film are subjected to abrasion tests.

First, the sheets of the disclosure and the related art were moved forward and backward 500 times under the condition that sandpaper CS-17 with a weight of 250 g is put thereon.

In result, abrasion occurred in both the disclosure and the related art (the thickness was abraded as much as 0.5 mm in the disclosure, and 0.4 mm in the related art). However, the disclosure showed that only the metal particles 130 from the abraded part were removed because the metal particles 130 were contained in the PVC base 110, but the related art showed that the antimicrobial coating film 330 coated on the surface was almost removed.

Here, the abrasion test was based on KS M ISO 5470-1 (2016).

Thus, germs were cultured on the surfaces, and the disclosure and the related art were compared. In result, 99.9% germs were killed in the disclosure, but 20% germs survived in the related art. Here, the germs test was based on the film covering method (TI-10-007).

The following <Table 2> shows results from antimicrobial activity tests.

TABLE 2
Substitute Specification (Clean Version)

| | | Viable Bacteria | Antimicrobial |
|---|---|---|---|
| Test microorganisms | Sort | Number (CFU/ml) | Activity(%) |
| Escherichia Coli | (A) | 1.3 × 105 | 99.9 |
| (ATCC 8739) | (B) | 4.9 × 106 | |
| | (C) | <10 | |
| Staphylococcus Aureus | (A) | 2.0 × 105 | 99.9 |
| (ATCC 6538) | (B) | 6.1 × 106 | |
| | (C) | 4.5 × 102 | |
| Pseudomonas Aeruginosa | (A) | 2.5 × 105 | 99.9 |
| (ATCC 9027) | (B) | 7.7 × 106 | |
| | (C) | 4.5 × 103 | |

A sample (i.e. a specimen subjected to the abrasion test according to the disclosure) was aseptically put on a sterilized Petri dish, and a test bacterial solution of 0.4 mL was dropped at the center on the surface of the sample. Then, a covering film was attached to the sample, and a lid was put on the dish. With this, germs were cultured for 24 hours at a temperature of 35±1° C. and a relative humidity of 90% or higher.

The related art may have a complicated process and cost much because the base, i.e. the PVC film is formed, and then the antimicrobial coating film is applied to or coated on the surface and/or rear of the PVC film. On the other hand, the disclosure shows a simpler process and remarkably better sterilization durability than the related art because the antimicrobial sheet is formed at once by mixing the metal particles 130 and other elements to the base 110, and the metal particles 130 are present close to both the surface and rear as mixed and contained in the base 110.

Accordingly, according to the disclosure, there is provided the antimicrobial sheet in which the metal particles having the antimicrobial function are present as integrally coupled to and uniformly distributed throughout the base of the construction material.

Further, there is provided the antimicrobial sheet in which the particles having the antimicrobial function are positioned as integrally coupled to the base and uniformly distributed to the surface and inside of the base, which is excellent in antimicrobial and sterilization durability and capable of eliminating the germs in contact with the surface thereof.

Further, there is provided the antimicrobial sheet in which the metal particles having the antimicrobial function are promoted to generate ions and active oxygen, thereby continuously keeping the antimicrobial function.

Further, there is provided the antimicrobial sheet which is easy and convenient to use as coupled to the surfaces of various the construction material.

The antimicrobial sheet 100 according to the disclosure is combined to various conventional construction materials as shown in FIGS. 2A to 2E, and it is thus possible to manufacture the construction materials having the antimicrobial function.

FIG. 2A is a cross-sectional view of a sterilized decorative tile in which the antimicrobial sheet is coupled to PVC, PET and PP base layers and PVC (or PET or PP) printed film layers; FIG. 2B is a cross-sectional view of a sterilized SPC tile in which the antimicrobial sheet is coupled to a stone plastic layer and PVC, PET, or PP printed film layers; FIG. 2C is a cross-sectional view of sterilized wallpaper in which the antimicrobial sheet is coupled to a paper print layer; FIG. 2D is a cross-sectional view of a sterilized decorative film in which the antimicrobial sheet is coupled to PVC, PET or PP printed film layers; and FIG. 2E is a cross-sectional view of a sterilized interior film in which the antimicrobial sheet is coupled to PVC, PET or PP printed film layer and an acrylic adhesive layer.

In addition, utilization of the antimicrobial sheet 100 according to another embodiment of the disclosure will be described below with reference to FIG. 3.

The floor material including the decorative tile and the SPC tile shown in FIGS. 2A and 2B may be subjected to UV coating to improve or enhance the surface of the antimicrobial sheet 100 in resistance to abrasion, surface hardness and outer appearance and to prevent contamination. In this case, the antimicrobial sheet 100 is positioned behind a UV coating layer and not exposed to the outside as shown in FIGS. 2A and 2B, and does not exert the antimicrobial function.

To solve this problem, a UV coating solution mixed with nanoparticles of metal (Ag, Cu, Zn, etc.) and zeolite, glycol, silica, etc. as shown in FIG. 3 to have the antimicrobial function may be coated on or applied to the surface of the film as shown in FIGS. 2A and 2B. With this structure, the UV coating layer also has the sterilization function as well as its original function. Although the UV coating layer is damaged by a scratch as used for a long time, it is possible to continuously keep the antimicrobial or sterilization function because the antimicrobial sheet of PVC, PET, PP, etc. present beneath the UV coating layer.

In this embodiment, a mixture may be made in a ratio of 90 wt % UV coating solution, 0.5˜10 wt % metal nanoparticle, 3˜10 wt % zeolite, 1˜15 wt % glycol, and 1˜15 wt % silica.

Thus, the antimicrobial sheet according to the disclosure is widely utilized and continuously keeps the antimicrobial function even though its coating surface is abraded.

Accordingly, there is provided an antimicrobial sheet in which metal particles having an antimicrobial function is not only integrally coupled to a base of a construction material but also uniformly applied throughout an entire area.

Further, there is provided an antimicrobial sheet, which is excellent in durability and kills germs on a surface thereof because particles having an antimicrobial function is positioned close to a surface of a base as integrally coupled to the base.

Further, there is provided an antimicrobial sheet, in which metal particles having an antimicrobial function are promoted to generate ions and active oxygen, thereby maximizing and continuously keeping antimicrobial functionality.

Further, there is provided an antimicrobial sheet which is simple and convenient to be used as coupled to surfaces of various construction.

Although a few exemplary embodiments of the disclosure have been shown and described, it will be appreciated by those skilled in the art that various changes and equivalent embodiments may be made in these exemplary embodiments without departing from the principles and spirit of the invention, the scope of which is defined in the appended claims and their equivalents.

1. An antimicrobial sheet formed with a base comprising a synthetic resin, the antimicrobial sheet comprising:
a fine metal particle mixed to the base; and
an auxiliary additive mixed to the base and the metal particle to uniformly distribute the metal particle in the formed sheet.

2. The antimicrobial sheet according to claim 1, wherein the metal particle comprises at least one of copper (Cu), silver (Ag), and zinc (Zn).

3. The antimicrobial sheet according to claim 1, wherein the metal particle has a size of 20˜200 μm.

4. The antimicrobial sheet according to claim 1, wherein the auxiliary additive comprises zeolite, glycol and silica.

5. The antimicrobial sheet according to claim 4, wherein, with respect to the base, the zeolite is 3˜25 wt %, the glycol is 0.5˜30 wt %, and the silica is 1˜10 wt %.

6. The antimicrobial sheet according to claim 1, wherein the metal particle of 0.3 wt %˜20 wt % is mixed with respect to the base.

7. The antimicrobial sheet according to claim 4, wherein, with respect to the base,
the metal particle comprises one among copper, silver and zinc and is 0.5 wt %˜20 wt %, and
the zeolite is 3 wt %˜25 wt %, the glycol is 1 wt %˜30 wt %, and the silica is 3 wt %˜10 wt %.

8. The antimicrobial sheet according to claim 4, wherein, with respect to the base,
the metal particle comprises copper and silver and is 0.5 wt %˜10 wt %, and
the zeolite is 3 wt %˜20 wt %, the glycol is 0.5 wt %˜15 wt %, and the silica is 1 wt %˜10 wt %.

9. The antimicrobial sheet according to claim 4, wherein, with respect to the base,
the metal particle comprises copper, silver and zinc and is 0.3 wt %˜15 wt %, and
the zeolite is 3 wt %˜20 wt %, the glycol is 0.5 wt %˜20 wt %, and the silica is 1 wt %˜10 wt %.

10. The antimicrobial sheet according to claim 4, wherein, with respect to the base,
the metal particle comprises copper and zinc and is 1 wt %˜10 wt %, and
the zeolite is 10 wt %˜20 wt %, the glycol is 5 wt %˜15 wt %, and the silica is 5 wt %˜10 wt %.

11. The antimicrobial sheet according to claim 4, wherein, with respect to the base,
the metal particle comprises copper and zinc and is 1 wt %˜20 wt %, and
the zeolite is 5 wt %˜20 wt %, the glycol is 5 wt %˜15 wt %, and the silica is 5 wt %˜10 wt %.

12. The antimicrobial sheet according to claim 1, wherein the base comprises polyvinyl chloride (PVC), polyethylene terephthalate (PET) and polypropylene (PP).

13. A construction material with the antimicrobial sheet according to claim 1, wherein the antimicrobial sheet is coupled to a surface or rear of the construction material comprising a floor material, wallpaper, and a decorative material.

14. The construction material according to claim 13, wherein
the base comprises a UV coating solution, and
metal particle of 0.5˜10 wt %, zeolite of 3˜10 wt %, glycol of 1˜15 wt % and silica of 1˜15 wt % are mixed with respect to the UV coating solution and applied or distributed to a surface of the construction material.

15. The antimicrobial sheet according to claim 2, wherein the metal particle has a size of 20˜200 μm.
